(19) United States
(12) Patent Application Publication
(10) Pub. No.: US 2014/0039876 A1
(43) Pub. Date: Feb. 6, 2014

(54) EXTRACTING RELATED CONCEPTS FROM A CONTENT STREAM USING TEMPORAL DISTRIBUTION

(71) Applicants: Craig P. SAYERS, Menlo Park, CA (US); Chetan K. GUPTA, San Mateo, CA (US); Riddhiman GHOSH, Sunnyvale, CA (US)

(72) Inventors: Craig P. SAYERS, Menlo Park, CA (US); Chetan K. GUPTA, San Mateo, CA (US); Riddhiman GHOSH, Sunnyvale, CA (US)

(21) Appl. No.: 13/563,658

(22) Filed: Jul. 31, 2012

(51) Int. Cl. G06F 17/27

(52) U.S. Cl. CPC G06F 17/2775
USPC 704/9

(57) ABSTRACT

A system may include an analysis engine to generate a set of candidate phrases from a content stream based on the temporal resolution, the interestingness, and/or the correlation of the candidate phrases.

### BACKGROUND

There are many publicly or privately available user generated content streams distributed on various networks. These content streams contain information relevant to various enterprises, such as retailers, sellers, producers, and event organizers. The content streams may contain, for example, the opinions of the users.

### BRIEF DESCRIPTION OF THE DRAWINGS

For a detailed description of various examples, reference will now be made to the accompanying drawings in which:

FIG. 1 shows a system in accordance with an example;

FIG. 2 also shows a system in accordance with an example;

FIG. 3 shows a method in accordance with various examples;

FIG. 4 shows a method in accordance with various examples;

FIG. 5 shows a method in accordance with various examples;

FIG. 6 shows a method in accordance with various examples;

FIG. 7 shows a graphical user interface in accordance with various examples;

FIG. 8 shows a graphical user interface in accordance with another example.

### DETAILED DESCRIPTION

NOTATION AND NOMENCLATURE: Certain terms are used throughout the following description and claims to refer to particular system components. As one skilled in the art will appreciate, component names and terms may differ between commercial and research entities. This document does not intend to distinguish between the components that differ in name but not function.

In the following discussion and in the claims, the terms “including” and “comprising” are used in an open-ended fashion, and thus should be interpreted to mean “including, but not limited to . . . .”

The term “couple” or “couples” is intended to mean either an indirect or direct electrical connection. Thus, if a first device couples to a second device, that connection may be through a direct electrical connection, or through an indirect electrical connection via other devices and connections.

As used herein the term “network” is intended to mean interconnected computers, servers, routers, devices, other hardware, and software, that is configurable to produce, transmit, receive, access, and process electrical signals. Further, the term “network” may refer to a public network, having unlimited or nearly unlimited access to users, (e.g., the internet) or a private network, providing access to a limited number of users (e.g., corporate intranet).

A “user” as used herein is intended to refer to a person that operates a device for the purpose of accessing a network.

The term “message” is intended to mean a sequence of words created by a user at a single time that is transmitted and accessible through a network. Generally, a message contains textual data and meta-data. Exemplary meta-data includes a time stamp or time of transmitting the message to a network.

The term “content stream” as used herein is intended to refer to the plurality of messages transmitted and accessible through a network over a given period of time.

As used herein the term “n-gram” is intended to refer to any number of words in a continuous sequence within a message. An n-gram does not extend beyond a terminating punctuation mark (e.g., period, question mark, etc.). Further, a message may contain a plurality of n-grams.

Also, as used herein the term “operator” refers to an entity or person with an interest in the subject matter or information of a content stream.

The term “metric” as used herein is used to refer to an algorithm for extracting subject matter or information from a content stream. Metrics include predetermined search parameters, operator input parameters, mathematical equations, and combinations thereof to alter the extraction and presentation of the subject matter or information from a content stream.

OVERVIEW: As noted herein, content streams distributed on various networks may contain information relevant to for example commercial endeavors, such as products, retailers, sellers, and events. The content streams are user generated and may contain general broadcast messages, messages between users, messages from a user to an entity or company, and other messages. In certain instances, the messages are social media messages broadcast and exchanged over a network, such as the internet. Generally, the content streams are textual, however audio and graphical content may be concurrent with the text.

A content stream may contain users' opinions that are relevant to an enterprise, such as a business or event, although the disclosed implementations are not limited to business. Analyzing a content stream for messages related to the enterprise provides managers or organizers with feedback from users that may not be accessible via other means and particularly, if the users are customers or potential customers. Thus, analysis of a content stream represents a tool in product evaluation and strategic planning.

However, a content stream may include many thousands of messages or in some circumstances, such as large events, many millions of messages. Although portions of the content stream may be collected and retained by certain collection tools, such as a content database, the volume of messages in a content stream make manual analysis, for example by relevance, a difficult and time consuming task for a person or organization of people. Additionally, the constant addition of messages to content streams makes extended manual analysis difficult.

SYSTEM: Various implementations are described herein of a system that is configured to automatically extract and analyze information from a content stream over time. The system may consult a configurable database for the metrics that are available for use in analyzing information from a content stream prior to, during, or after extraction. The algorithms that populate the database may be configured by an operator prior to or during extraction and analysis operations. Thus, by altering a metric an operator provides themselves with a different result or different set of extracted and analyzed information.

The system, made up of the database with metrics, algorithms that dictate the analysis of the information, and the presentation of the analyzed data may be considered a series of engines in an analysis system. In implementations the system may be configured as an analysis engine including an extraction engine, a distribution engine, and a condensing engine in sequence. Generally, the extraction engine is configured to generate a set of candidate data from a content stream having temporal resolution. Additionally, the extraction engine excludes candidate data from the content stream that fails to meet a minimum frequency within the duration of the extraction. The distribution engine creates temporal distributions by receiving and grouping the candidate content data into a plurality of groups to form a histogram. In instances, the groups have an equal weighting, or equal number of candidate data therein. The condensing engine, accesses the plurality of equal groups to statistically evaluate the candidate content data, exclude portions of the candidate content data, and merge related portions of the candidate content data according to the temporal distribution of the candidate content data in the groups.

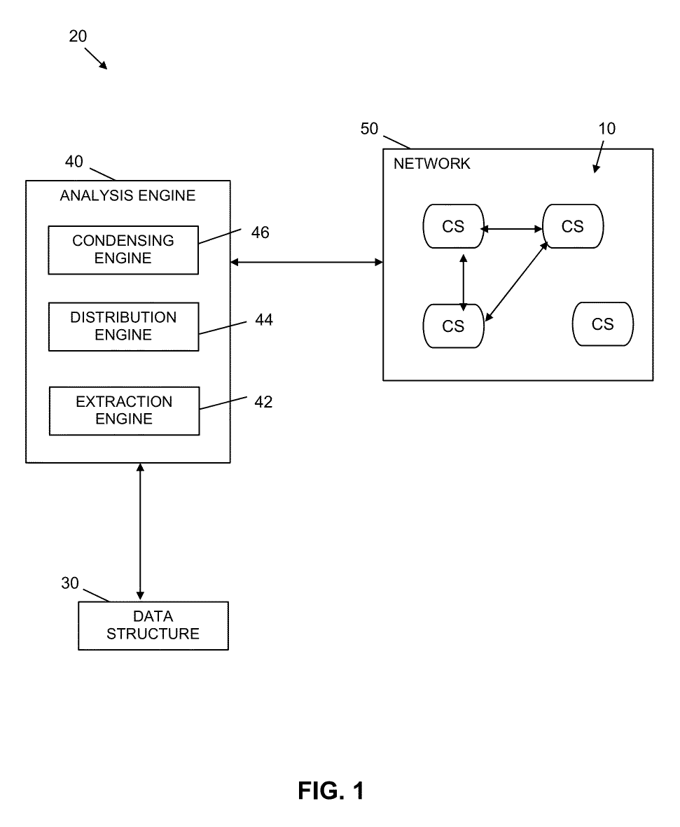

FIG. 1 shows a system 20 in accordance with an example including a data structure 30, an analysis engine 40, and a network 50. The network 50 includes various content streams (CS) 10. Generally, the network 50 is a publicly accessible network of electrically communicating computers, such as but not limited to the internet. In certain instances, the content stream 10 may be on limited access or private network, such as a corporate network. Some of the content streams 50 may be coupled or linked together in the example of FIG. 1, such as but not limited to social media streams. Other content streams 10 may be standalone, such as user input comments or reviews to a website or other material. In some implementations, certain content streams 10 are stored by the data structure 30 after accessing them via the network 50. Each content stream 10 represents a plurality of user generated messages.

The analysis engine 40 in the system includes the extraction engine 42, the distribution engine 44, and the condensing engine 46 as described previously. The analysis engine processes the content streams 10 obtained from the network 50 and presents results to an operator via the extraction engine 42, the distribution engine 44, and the condensing engine 46. In some implementations, metrics stored in the data structure 30 provide the analysis engine 40 operational instructions for operations related to the various engines in order to alter the process. Further, information stored in the data structure 30 includes one or more metrics utilized in operation of the analysis engine 40 that are changeable by an operator of the system 20. The changeable metrics enable the operator to alter the process and presentation of results during implementation. The metrics, including how they are used, how they are changed, and how the results are presented to an operator, are described hereinbelow. The process may include determining content streams 10 that are available on the network 50.

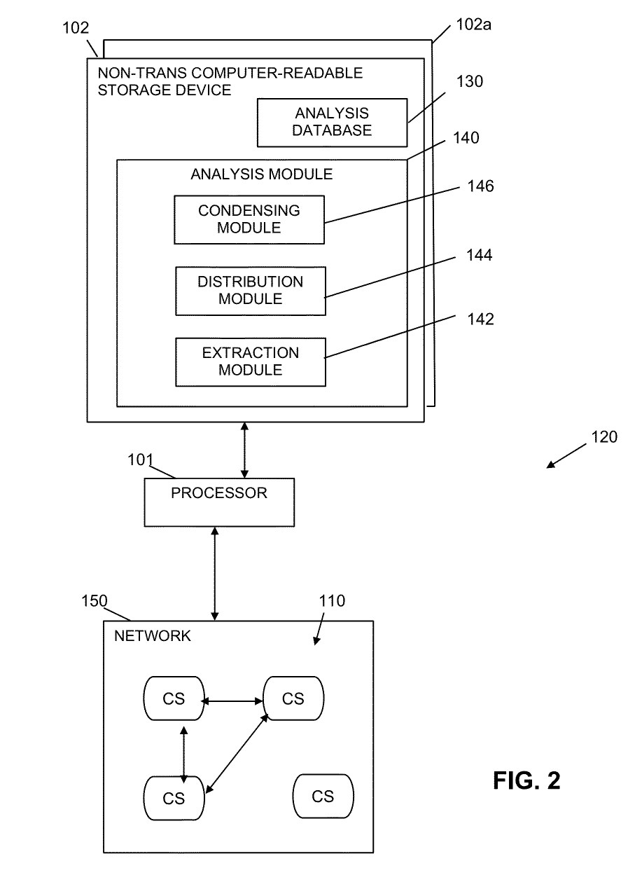

In some implementations, each engine 42-46, may be implemented as a processor executing software. FIG. 2 shows an illustrative implementation of a processor 101 coupled to a storage device 120, as well as the network 150 with content streams 110. The storage device 102 is implemented as a non-transitory computer-readable storage device. In some examples, the storage device 102 is a single storage device, while in other configurations the storage device 102 is implemented as a plurality of storage devices (i.e., 102, 102a). The storage device 102 may include volatile storage (e.g., random access memory), non-volatile storage (e.g., hard disk drive, Flash storage, optical disc, etc.) or combinations of volatile and non-volatile storage, without limitation.

The storage device 102 includes a software module that corresponds functionally to each of the engine of FIG. 1. The software module may be implemented as an analysis module 140 having an extraction module 142, a distribution module 144, and a condensing module 146. Thus each engine 42-46 of FIG. 1 may be implemented as the processor 101 executing the corresponding software module of FIG. 2.

In implementations, the storage device 102 shown in FIG. 2 includes an analysis database 130. The analysis database 130 is accessible by the processor 101 such that the processor 101 is configured to read from or write to the analysis database 130. Thus, the data structure 30 of FIG. 1 may be implemented by the processor 101 executing corresponding software analysis modules 142-146 and accessing information obtained from the corresponding analysis data base 130 of FIG. 2.

PROCESS: Generally, the system herein is configured to provide an operator a result from the completion of a process. In implementations, the process is interactive, in that the operator may change a metric as above in order to alter the result from the process. In implementations, the process relates to extracting candidate phrases from a content stream and analyzing the extracted candidate phrases for concepts of interest to the operator. The analysis includes determining the temporal distributions of the candidate phrases and the relevance in the context of the candidate phrases. In implementations described herein, selecting candidate phrases for display includes the sequential steps of thresholding to remove infrequent phrases, an interestingness determination, correlation determination, simplification and merging operations, and a relevance determination.

The discussion herein will be directed to concept A, concept B, and in certain implementations a concept C, within a content stream. The concepts A-C processed according to the following provide at least one result that is available for operator review, analysis, and manipulation. Thus, each operation may be altered by an operator of the system previously described and detailed further hereinbelow. In some implementations certain operations may be excluded, reversed, combined, altered, or combinations thereof as further described herein with respect to the process.

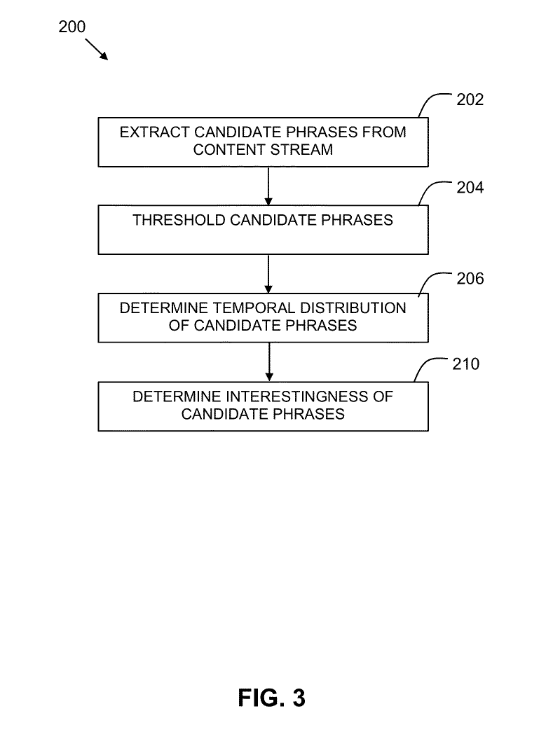

Referring now to FIG. 3, there is illustrated a block flow diagram of the process 200. The process 200 includes the operations of extracting 202 candidate phrases, thresholding 204 a portion of the candidate phrases, determining 206 the temporal distribution of the candidate phrases, and determining 210 the interestingness of the candidate phrases. The operations may be performed in the order shown, or in a different order. Two or more of the operations may be performed in parallel, instead of serially. The operations of FIG. 3 are described in greater detail below.

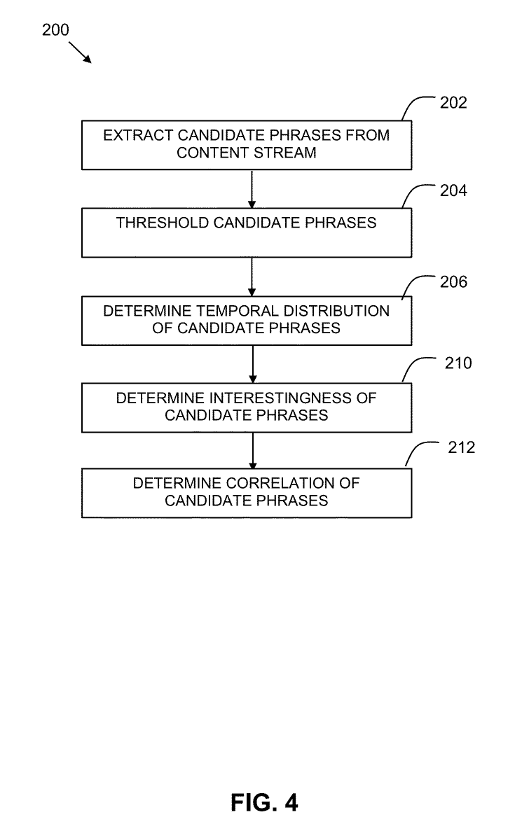

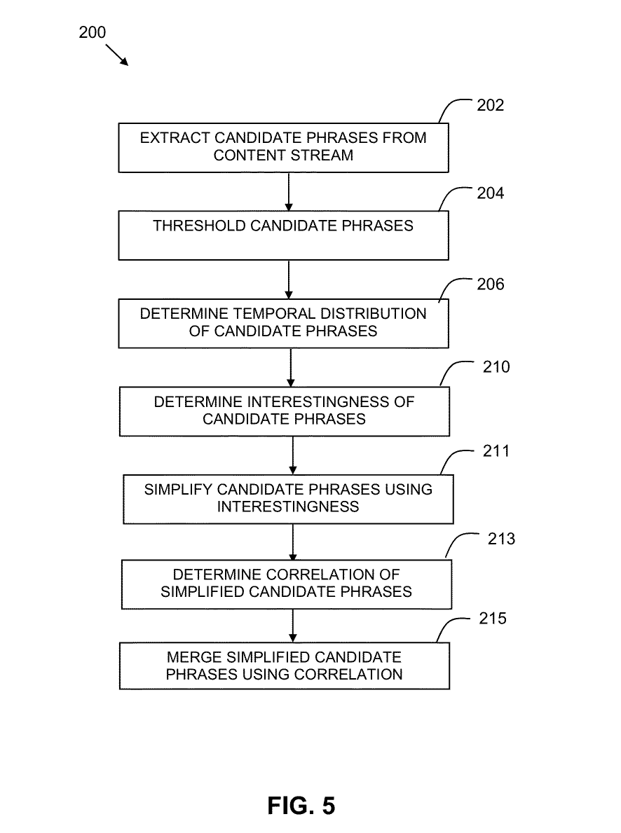

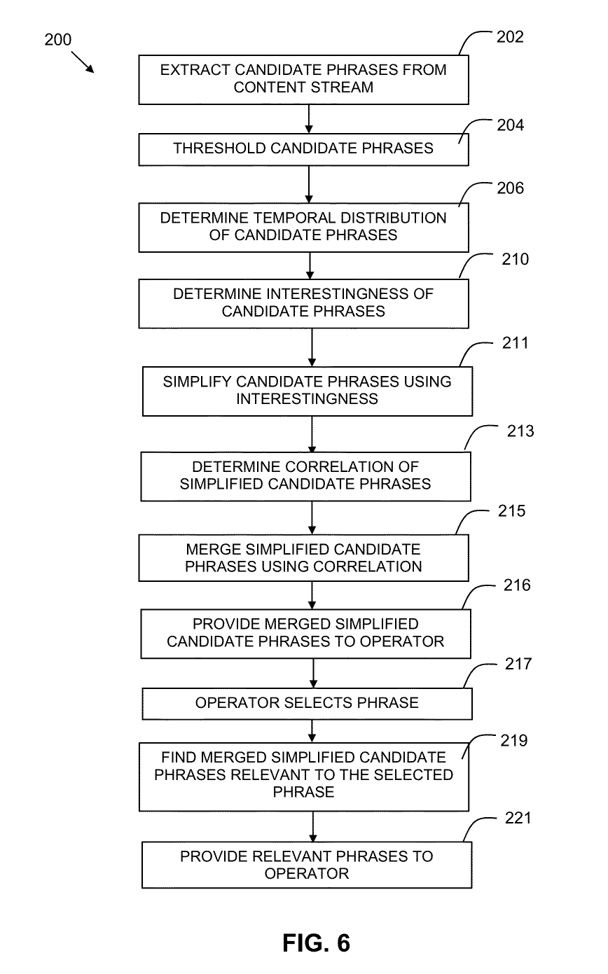

In the implementation illustrated in FIG. 4, determining the interestingness of the candidate phrases is followed by determining 212 the correlation of the candidate phrases. Further, in certain implementations of the process 200, the candidate phrases may be simplified 211 using the interestingness and merged 215 using the correlation 213 as illustrated in FIG. 5. Also, subsequent to determining merged simplified candidate phrases, these may be displayed for an operator 216, and when the operator chooses a phrase 217, relevant phrases can be found 219 and displayed 221 as shown in FIG. 6.

The following description is related to the process 200 as illustrated in FIGS. 3 through 8. More specifically, the process 200 includes the operations of extracting 202 candidate phrases and thresholding 204 a portion of the candidate phrases, for example via the extraction engine 42 of FIG. 1. In operations, determining 206 the temporal distribution of the candidate phrases is via the distribution engine 44 of FIG. 1. In certain instances, each of the operations may have a predetermined metric, or a changeable metric under operator control as described herein. Further, the metric may be threshold set for the result of each operation, such as the non-limiting examples: a minimum, a maximum, or a combination thereof.

In implementations of the operation of extracting 202 the candidate phrases by the extraction engine 42 of FIG. 1, the messages of the content stream are parsed or divided into n-grams. Thus, the n-grams may be considered the candidate phrases for the process 200. As described, the n-gram is a number “n” of sequential words in a phrase. In certain implementations, the maximal n-gram for a message is defined by sentence delineating punctuation. Subsequent, overlapping n-grams have fewer words than the maximal n-gram. For example, a six-word sentence in a message will have 1 six-word n-gram, 2 five-word n-grams, 3 four-word n-grams, and continuing down to 6 one-word n-grams and as such a six-word sentence in a message has 21 n-grams or 21 candidate phrases. While overlapping n-grams have overlapping words and may have a related concept, they are incorporated into the total of extracted n-grams for the messages in a content stream.

In the operation of extracting 202 the candidate phrases, the length of the n-gram provides a predetermined metric to reduce overlapping n-grams. In certain implementations, a content stream having a significant number of messages, extracted accordingly may result in an extreme number of n-grams for subsequent operations in the process 200. Thus, n-grams may be limited to a predetermined maximal length. Additionally, a predetermined minimum n-gram length may be provided. Alternatively, the n-gram minimum and maximum length may be controllable or alterable by an operator during the operation of extracting 202. In implementations, the operation of extracting 202 the candidate phrases from the content stream messages provides n-grams having a length between the minimum and maximum.

The operation of thresholding 204 a portion of the candidate phrases may be considered excluding a portion of the candidate phrases by the extraction engine 42 of FIG. 1. In implementations, thresholding 204 the candidate phrases is based on the frequency f of a candidate phrase within the total number of candidate phrases in a content stream. In certain instances, the frequency f may be determined by the relationship in equation 1:

f_{(n-gram)}=N_{(# of messages containing n-gram)}/T_{(# of messages)} (Eq. 1)

wherein, N is the number of messages containing a discrete n-gram and T is the total number of messages. As n-grams are the candidate phrases, the frequency of the candidate phrases is likewise determined by this relationship. Thresholding 204 the candidate phrases relates to removing the candidate phrases having a frequency f below a predetermined frequency threshold. The thresholding operation 204 may have any predetermined frequency threshold between 100% and 0%. In exemplary implementations, the threshold frequency may be predetermined at less than about 1%. Thus, all candidate phrases with a frequency of less than about 1% may be excluded or removed from the process 200 at this operation. Alternative implementations may include the candidate phrases with a frequency of less than about 0.1% are thresholded in the process 200. In certain implementations, a threshold of less than about 0.01% may be utilized. Alternatively, the operation of thresholding 204 may be controllable or alterable by an operator such that different frequency f thresholds may be provided.

For the distribution engine 44 shown in FIG. 1, the operation of determining 206 the temporal distribution of the candidate phrases relates to grouping the candidate phrases by time. More specifically, as each message in the content stream has meta-data including a time stamp, the candidate phrases extracted from the messages are assigned to a group (‘grouped’) based on the time of transmission to a network. The time of transmission from each message is maintained with the extracted candidate phrases. In some implementations, the time of transmission may be considered the creation time of the message.

In implementations, determining 206 the temporal distribution of the candidate phrases includes grouping (“binning”) the candidate phrases based on the time stamp. More specifically, determining 206 the temporal distribution incorporates groups having an equal number of candidate phrases. The groups themselves are temporarily organized, such that the candidate phrase having the earliest time stamp is in the first group. Additionally, in this implementation each candidate phrase contains equal weight within each group. Thus, the operation of determining 206 the temporal distribution is applying a equi-height histogram to the candidate phrases based on the time stamp, as described according to Equation 2:

A=[a₁, a₂, a₃, . . . aₙ] (Eq. 2)

wherein A the temporal distribution of the candidate phrases, aᵢ is the number of candidate phrases assigned to the “i-th” group. In further implementations, determining 206 the temporal distribution of the candidate phrases includes scaling the temporal distribution of the candidate phrases:

A′=[a′₁, a′₂, a′₃, . . . a′ₙ]; a′₁=aᵢ/max(A) (Eq. 3)

Scaling the temporal distribution (A′) of the candidate phrases, comprises the ratio of aᵢ to the max(A) for each a′ᵢ in the Equation 3. As described, grouping and scaling the candidate phrases during determining 206 the temporal distribution provides a weighted histogram for message frequency.

Determining 206 the candidate message temporal distribution according to the above provides for determining the variation in the number of messages and the candidate phrases extracted therefrom with respect to time. More specifically, the duration from the first message to the last message in a group changes with the volume of candidate phrases extracted. Thus, determining 206 the temporal distribution normalizes the number of candidate phrases according to time. In implementations, the number of candidate phrases assigned to each group may be a predetermined metric. Alternatively, the number of candidate phrases in the groups may be a controllable or alterable metric. As such, an operator controls the number of candidate phrases assigned to each group, for example, to control the overall resolution of the temporal distribution.

Referring again to FIG. 3, there is illustrated a block flow diagram of an example implementation of the process 200 via the system 20 of FIG. 1. The process 200 includes the operations of extracting 202 candidate phrases, thresholding 204 a portion of the candidate phrases, for instance via the extraction engine 42; determining 206 the temporal distribution of the candidate phrases via the distribution engine 44, and determining 210 the interestingness of the candidate phrases In this implementation of the system, the distribution 44 and the condensing engine are co-utilized.

The interestingness of a candidate phrase may be determined by a statistical analysis of the temporal distribution of a candidate phrase. Thus, the frequency of the candidate phrases within each group and all groups provides an interestingness factor or coefficient within the process. In implementations, phrases which occur relatively uniformly across all the groups are less interesting. Further, there may be a plurality of statistical computations, factors, coefficients, or combinations thereof, involved in the operation of determining 210 the interestingness.

In exemplary implementations, determining 210 the interestingness of the candidate phrases includes scaling each candidate phrase frequency across the temporal distribution. More specifically, the interestingness of a candidate phrase is a weighted average calculated from a sum of the scaled temporal distribution (e.g., see A′ from Equation 3) across all the groups. Thus, the determining 210 the interestingness for candidate phrases includes the calculation in Equation 4:

I(A′)=1−G⁻¹ [Σa′ᵢ(for all i, 1 to G)] (Eq. 4)

wherein I is the interestingness for the temporal distribution A′, G is the number of groups, and a′ᵢ is the scaled number of candidate phrases in a group i. The result is the average frequency of the candidate phrase, and subtracting the average frequency from 1 (i.e., 100% frequency), determines the interestingness. Thus, with a lower weighted average frequency of the candidate phrase in each group and across all groups, it is determined to be more interesting.

In other exemplary implementations, determining 210 the interestingness of the candidate phrases includes determining the coefficient of variation of the temporal distribution for each candidate phrase. The variation of the temporal distribution is calculated from the average frequency of the candidate phrase in each group and the standard deviation thereof. More specifically, the product of the standard deviation divided by the average frequency of the candidate phrase determines interestingness as shown in Equation 5:

I(A)=Std. Dev(A)/Mean(A) (Eq. 5)

wherein, I is the interestingness factor for the temporal distribution A. In this implementation high variation of the candidate phrases within the temporal distribution groups provides a higher interestingness factor. The interestingness factor for each candidate phrase may have a predetermined minimum, maximum, or a combination thereof for continuing according to the process 200. Further, the interestingness factor minimum, maximum, or a combination thereof may be controllable or alterable by an operator. Thus, the operator controls further analysis according to the process 200 based at least partially on the interestingness factor “I”.

Referring now to FIG. 4 specifically, there is illustrated another example of the process 200 by system 20 of FIG. 1. The process 200 includes the operations of extracting 202 candidate phrases, thresholding 204 a portion of the candidate phrases via the extraction engine 42; determining 206 the temporal distribution of the candidate phrases via the distribution engine 44; and determining 210 the interestingness of the candidate phrases. Additionally, determining 212 the correlation of at least two of the candidate phrases.

In implementations, determining 212 the correlation of the candidate phrases includes calculating a co-occurrence or correlation factor C for the at least two temporal distributions of candidate phrases. Generally, the higher the frequency of co-occurrence of the at least two candidate phrases in temporal groups and across the temporal distribution, the higher the correlation of the candidate phrases.

In exemplary implementations, the correlation factor may be a product of the frequency of each of the candidate phrases within a temporal group and the temporal distribution. Thus, determining 212 the correlation may be the considered an intersection calculation, such that the values representing the frequency that the at least two candidate phrases are found in the same temporal group are used. The intersection of co-occurrence is divided by the union (i.e., the sum) of total frequency of the each of the candidate phrases in each of the temporal groups and the temporal distribution. Thus, determining 212 the correlation factor between at least two candidate phrases may be represented by the Equation 6:

C(A′,B′)=(A′ ∩ B′)/(A′ ∪ B′) (Eq. 6)

wherein, R is the correlation factor for the temporal distributions of candidate phrases A′ and B′. Further, utilizing scaled distributions, the operation of determining 212 the correlation factor C may be also be represented by the Equation 7:

C(A′,B′)=Σ [min(a′ᵢ, b′ᵢ)]/[max(a′ᵢ, b′ᵢ) (Eq. 7)

for the scaled candidate phrases a′ᵢ, b′ᵢ in a temporal group i. Thus, in this example implementation for determining 212 the correlation of at least two candidate phrases, the correlation factor is between 0 and 1. At or approximate to 0 the candidate phrases A, B are uncorrelated. Conversely, a correlation factor “C” at or approaching 1 signifies that the candidate phrases are highly correlated. In further implementations, the correlation may be multiplied by 100 in order to provide an approximate correlation percentage.

In another exemplary implementation, the calculation of the correlation factor, C, between two candidate phrases may be performed using Pearson's Correlation Coefficient illustrated in Equation 8:

$$C ( {A}_{t} {B}^{′} ) = \frac{{\sum }_{t = 1}^{N} ( {a}_{t} - a ) ( {b}_{t} - \text{?} )}{\sqrt{{\sum }_{t = 1}^{N} {( {a}_{t} - \text{?} )}^{2} {\sum }_{t = 1}^{N} {( {b}_{t} - \text{?} )}^{2}}} \\ \text{?} \text{indicates text missing or illegible when filed} \qquad ( Eq . 8 )$$

wherein, the correlation factor varies between −1 and +1, with higher values being the most correlated. By adding 1, and multiplying by 50, an approximate correlation percentage may again be obtained.

As described herein, the correlation percentage for the at least two candidate phrases may have a predetermined minimum or maximum value between 0 and 100 for further analysis in the process 200. Further, the minimum or maximum value may be controllable or alterable by an operator. Thus, the operator controls the process 200 based on the correlation factor ‘C’.

Referring now to FIG. 6, there is illustrated another example implementation of the process 200 by system 20 of FIG. 1. The process 200 includes the operations of extracting 202 candidate phrases, thresholding 204 a portion of the candidate phrases via the extraction engine 42; determining 206 the temporal distribution of the candidate phrases via the distribution engine 44; determining 210 the interestingness of the candidate phrase; determining 213 the correlation of the candidate phrases; and merging the 215 the correlated simplified candidate phrases according to an operator determined concept via the condensing engine 46.

Referring now to FIG. 5, there is illustrated another example of the process 200 by system 20 of FIG. 1. The process 200 includes the operations of extracting 202 candidate phrases, thresholding 204 a portion of the candidate phrases via the extraction engine 42; determining 206 the temporal distribution of the candidate phrases via the distribution engine 44; and determining 210 the interestingness of the candidate phrase. The process includes simplifying 211 candidate phrases, computing correlation among the simplified candidate phrases 213, and then merging the simplified candidate phrases 215 within the condensing engine 46. Simplifying candidate phrases involves selecting a subset of the phrases for subsequent processing and ultimately presentation to a user.

For example, according to one implementation, consider all candidate phrases αβ, which are the concatenation of two candidate phrases α and β. If α or β is uninteresting as determined as described herein, and the remainder occurs in many other n-grams, then delete the longer phrase αβ. In one implementation, this may be as shown in Equation 9:

I(α)<0.8 and #(β)>3 #(αβ) or I(β)<0.8 and #(α)>3 #(αβ) (Eq. 9)

Additionally, according to this implementation, remove all candidate phrases which contain an n-gram which occurs in many other phases. In nonlimiting examples, those containing an n-gram with interestingness computed using coefficient of variation >1.5 and which occurs 10 times more often in other phrases.

Referring again to FIG. 6, the correlation of the simplified candidate phrases 213, is implemented using the same algorithm as the correlation of candidate phrases 212, the only difference is that it is performed on the subset of candidate phrases remaining after simplification 211.

In some implementations the merging 215 operation involves finding two simplified candidate phrases which are highly-correlated, and where one is a subset of the other, and where the shorter phrase is not a lot more common. In these implementations of the process 200, the longer candidate phrase is retained and merged with the shorter candidate phrase temporal resolution. The shorter length correlated candidate phrase is excluded from the process thereafter, and thereby removing still further redundant candidate phrases.

In a further implementation, the operation of merging 215 the simplified correlated phrases includes thresholding a portion of the merged candidate phrases. Thresholding the candidate phrases has been previously described herein with respect to the operation of thresholding 204 the extracted candidate phrases. The thresholding portion of merging 215 operation occurs according to an analogous process. Further, exemplary thresholds may be any one of the predetermined values for the merged interestingness factor, the merged correlation factor, the merged temporal distribution and frequency thereof, and combinations thereof. Additionally, each of the exemplary thresholds may have a minimum, a maximum, or a combination thereof, such that a merged candidate phrase having a value outside of the predetermined range is excluded from the process 200. Still further, any of the thresholds utilized for simplifying 211 the candidate phrases, determining 213 the correlation of the simplified phrases, and merging 215 the simplified, correlated phrases may be controllable or alterable by an operator.

Referring now to FIG. 6, there is illustrated a process 200 as described herein for operating the system 20 of FIG. 1. In the illustrated implementation after merging the correlated candidate phrases, the process includes providing 216 the simplified candidate phrases to the operator, for example via a graphical user interface (GUI). Generally, the GUI includes a means of providing the operator visual indicators related to some property of the simplified phrases.

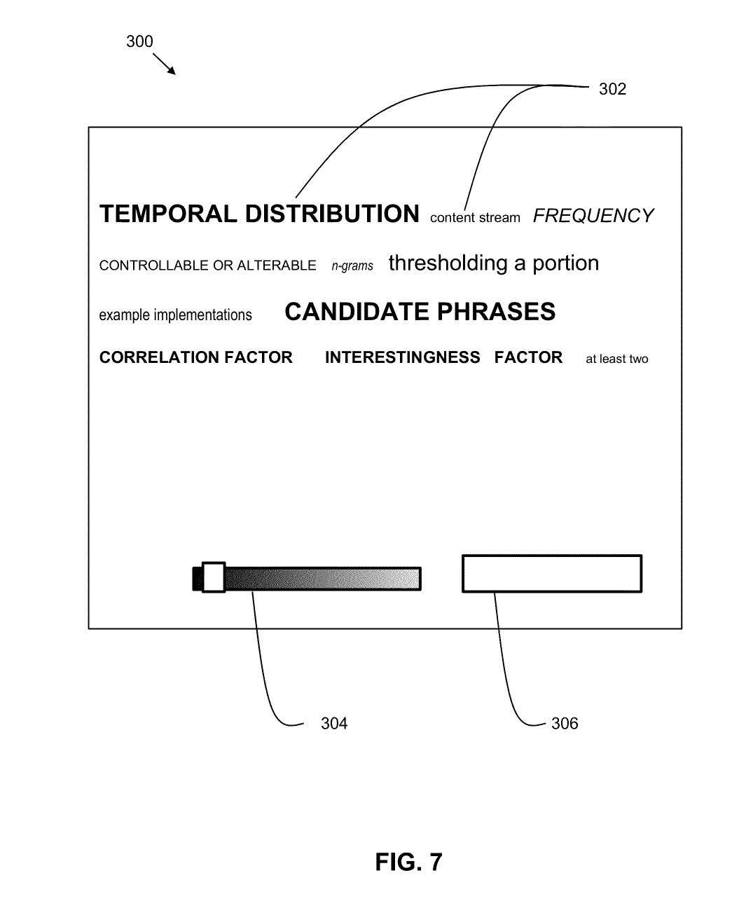

Referring to FIG. 7, there is illustrated an exemplary implementation of a GUI 300. The GUI 300 is shown as a textual heat map of the simplified phrases 302 may be provided as a textual heat map. More specifically, a textual heat map is a graphical display of the simplified phrases provided by the system 100 and the process 200 illustrated in FIGS. 1 through 8. Each simplified phrase has at least one visual indicator related to at least one operation of the process 200. Exemplary visual indicators for providing (216) the simplified candidate phrases to an operator include font, size, color, intensity, gradation, patterning, and combinations thereof and without limitation. Further, the visual indicators may be indicative of at least one metric such as quantity, frequency, time, interestingness, correlation, relevance, and combinations thereof determined by at least one calculation, threshold, value, or combination thereof in at the at least one operation of the process 200.

In implementations, the GUI 300 may include an operator manipulatible control 304. The control 304 confers interactivity to the system 100 and the process 200. The control 304 may be located anywhere on the GUI 300 and include any graded or gradual control, such as but not limited to a dial or a slider (as shown). The control 304 is associated with at least one metric such as frequency, time, interestingness, correlation, relevance, and combinations thereof without limitation determined by at least one calculation, threshold, value, or combination thereof in at least one operation of the process 200. In response to the operator manipulating the control 304 the metric changes such that process 200 provides different results. Additionally, the at least one visual indicator dynamically changes in response to the operator manipulated of control 304 and the associated metric. The visual indicator would show an operator at least one change in the font, size, color, intensity, gradation, patterning, and combinations thereof without limitation, within the textual heat map described above. Thus, the control 304 is an input for the system 100 to alter a metric. The GUI 300 includes a search or find interface 306, such that the operator may input or specify a simplified phrase for the system 100 to utilize as a metric for the process 200.

Referring now to FIGS. 9 and 10, the GUI 300 permits selecting at least one of the merged simplified candidate phrases 302 for further analysis according to process 200 on system 100. This selection presents operator GUI 400, having the analysis from process 200 relevant to the simplified candidate phrase 402 that was selected. More specifically, the GUI 400 provides operator at least one control 404. As previously described the control 404 is associated with at least one metric of the simplified candidate phrase 402 such as frequency, time, interestingness, correlation, relevance, and combinations thereof without limitation determined by at least one calculation, threshold, value, or combination thereof in at least one operation of the process 200. The GUI 400 additionally allows the operator to select a phrase 217.

Referring again to FIG. 6, once the user has selected a phrase 217, the system finds merged simplified candidate phrases which are relevant to the selected phrase 219, and displays them for the user, 221. In one implementation the determination of relevance is performed by computing the correlation between all phases and the selected phrase, and then selecting for display those which are both most highly-correlated and the most interesting. The correlation may be computed in the same way described for the correlation in step 215, and the interestingness measured in the same way described in step 210. In an additional implementation, the correlation may be performed using an asymmetrical function, for example by weighting the groups, where the weight is high for groups in which the first phrase commonly occurs and lower for other areas.

It should be apparent that the steps need not be performed in the order described. For example, in one implementation, the selection of relevant phrases is performed for all phrases before any are shown to the operator 217. It should further be apparent that there are a number of other possible heuristics for merging and simplifying the candidate phrases using measures of interestingness and correlation in combination with common statistical measures for phrase occurrence in messages.

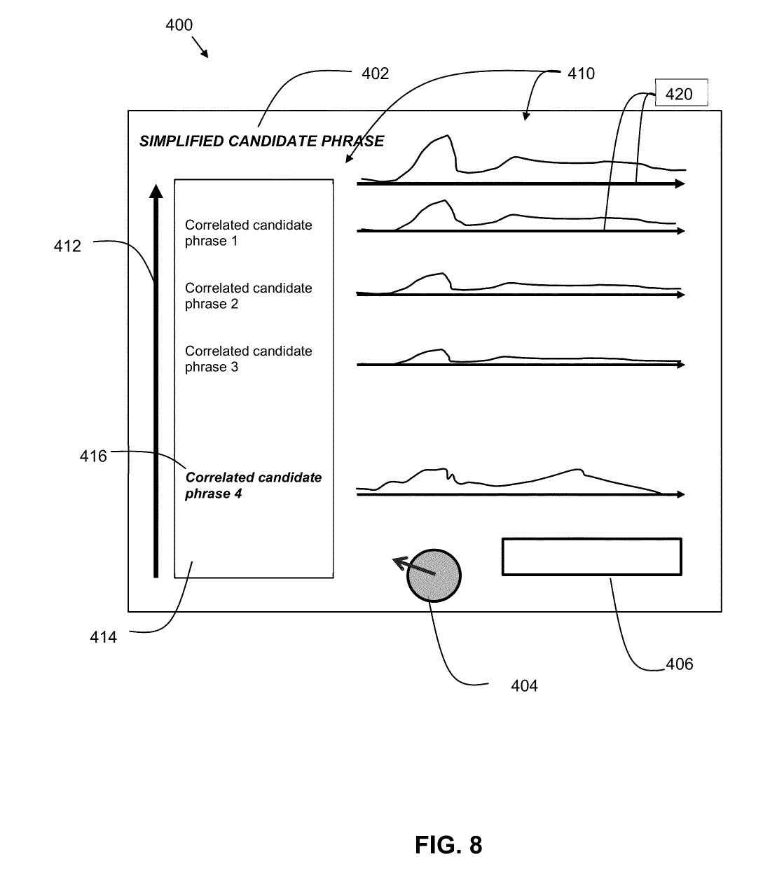

The GUI 400, displays the relevant phrases to the operator as shown in FIG. 8. The GUI 400 for the merged simplified candidate phrase 402 selected by the operate includes at least one graphical display 410 related to at least one operation in process 200. Non-limiting examples of graphical displays 410 include indicators of at least one of the correlated candidate phrase frequency 412, weighted or ranked correlated phrases 414, interestingness factor 416, temporal resolution 420, total temporal groups 412, and other determinations from process 200 on system 100. In response to the operator manipulation of control 404 (e.g., a dial as illustrated) the metric changes such that process 200 provides different results with respect to the simplified candidate phrase 402. Additionally, the at least one visual indicator in the graphical displays 410 in response to the operator manipulated of control 404 and the associated metric. Thus, the control 404 is an input for the system 100 to alter a metric with respect to a simplified candidate phrase 402. The GUI 300 includes a search or find interface 306, such that the operator may input or specify a simplified phrase for the system 100 to utilize as a metric for the process 200.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising
extracting candidate phrases from a content stream;
thresholding the candidate phrases below a minimum frequency for each candidate phrase;
determining a temporal distribution of the candidate phrases;
determining interestingness of the candidate phrases,
wherein determining interestingness of the candidate phrases comprises statistically analyzing the temporal distribution of a candidate phrase; and
displaying the candidate phrases.

2. The method of claim 1, wherein determining the temporal distribution comprises separating the candidate phrases into groups based on a time stamp.

3. The method of claim 2, wherein separating the candidate phrases into groups, comprises groups having a uniform number of candidate phrases.

4. The method of claim 1, wherein determining interestingness of each candidate phrase comprises:
scaling each candidate phrase frequency across the temporal distribution and computing the average of those scaled values or,
determining a coefficient of variation of the temporal distribution for each candidate phrase.

5. The method of claim 1, further comprising simplifying the candidate phrases by removing excess words after determining interestingness of the candidate phrases.

6. The method of claim 1, further comprising:
determining the correlation of the candidate phrases; and
merging the correlated candidate phrases.

7. The method of claim 6, further comprising removing merged candidate phrases below a predetermined threshold.

8. The method of claim 1, wherein displaying the candidate phrases further comprises providing the candidate phrases to an operator by an interface having at least one control for at least one metric of the candidate phrases.

9. The method of claim 8, further comprising determining the relevance to an operator selected candidate phrase.

10. The method of claim 9, wherein determining the relevance comprises determining a correlation between the candidate phrases and the operator selected candidate phrase.

11. The method of claim 10, further comprising determining the interestingness of the candidate phrases correlated to the operator selected candidate phrase.

12. The method of claim 11, further comprising displaying the highest correlated and the most interesting candidate phrases to an operator.

13. The method of claim 8, further comprising
altering at least one metric of the candidate phrases; and
altering a visual cue indicative of the displayed candidate phrases within the interface.

14. A non-transitory, computer-readable storage device containing software than, when executed by a processor, causes the processor to:
extract a plurality of candidate phrases from a content stream;
exclude the candidate phrases occurring below a minimum frequency within the content stream;
group the candidate phrases in a temporal distribution according to an associated time stamp;
determine the interestingness and correlation of each of the candidate phrases; and
simplify the candidate phrases and
merge the candidate phrases;
wherein the determine the interestingness and correlation of each the candidate phrases comprises statistical analysis of the extracted candidate phrases.

15. The non-transitory, computer-readable storage device of claim 14 wherein the software causes the processor to group the candidate phrases in equal sized groups.

16. The non-transitory, computer-readable storage device of claim 14 wherein the software causes the processor to:
scale each candidate phrase frequency across the temporal distribution; or
calculate the variation of the temporal distribution for each candidate phrase by the ratio of the candidate phrase frequency standard deviation to the candidate phrase frequency average;
to determine the interestingness of each candidate phrase.

17. The non-transitory, computer-readable storage device of claim 14 wherein the software causes the processor to:
calculate the product of the frequency of each of the candidate phrases within a temporal group and frequency of each of the candidate phrases within the temporal distribution; or
calculate Pearson's Coefficient of Correlation;
to determine the correlation of each candidate phrase.

18. A system, comprising:
an extraction engine to generate a set of candidate phrases from a content stream with temporal resolution and exclude candidate phrases having a frequency below a threshold;
a distribution engine to distribute the candidate phrases into a plurality of groups based on the temporal resolution of the candidate phrases; and
a condensing engine to simplify the candidate phrases by the interestingness and the correlation of the candidate phrases, wherein the condensing engine excludes one portion of the candidate phrases and merges another portion of the candidate phrases.

19. The system of claim 18, wherein the distribution engine distributes the candidate phrases such that each of the plurality of groups has an equal number of candidate phrases.

20. The system of claim 18, wherein the condensing engine merges a portion of the candidate phrases based on the correlation of the candidate phrases.
